(19) United States
(12) Patent Application Publication
(10) Pub. No.: US 2026/0066780 A1
(43) Pub. Date: Mar. 5, 2026

(54) RESONANT POWER CONVERSION CIRCUIT CONTROLLED BY INTEGRAL RESULT OF FEEDBACK SIGNAL

(71) Applicant: Richtek Technology Corporation, Zhubei City (TW)

(72) Inventors: Tzu-Chen LIN, Zhubei City (TW); Ta-Yung YANG, Taoyuan City (TW)

(21) Appl. No.: 19/276,260

(22) Filed: Jul. 22, 2025

Related U.S. Application Data
(60) Provisional application No. 63/689,903, filed on Sep. 3, 2024.
(60) Provisional application No. 63/698,640, filed on Sep. 25, 2024.

(30) Foreign Application Priority Data
May 29, 2025 (TW) 114120228

(51) Int. Cl. H02M 3/00; H02M 1/00; H02M 1/32

(52) U.S. Cl. CPC H02M 3/01; H02M 1/0009; H02M 1/0025; H02M 1/32

(57) ABSTRACT

A power conversion circuit includes a transformer, a resonant capacitor, a high-side transistor, a low-side transistor, a current detection circuit, a feedback circuit, and a control circuit. The transformer includes a primary coil connected with the resonant capacitor in series. The high-side transistor and the low-side transistor are coupled to the primary coil. The current detection circuit detects a resonant current flowing through the resonant capacitor to generate a current detection signal. The feedback signal generates a feedback signal based on the output voltage of the power conversion circuit. The control circuit integrates a superposition signal of the current detection signal and a slope compensation signal to generate a first integrated signal, integrates the feedback signal to generate a second integrated signal, and compares the first integrated signal to the second integrated signal to drive the high-side transistor and the low-side transistor.

### CROSS REFERENCE TO RELATED APPLICATIONS

This application claims the benefit of U.S. Provisional Application No. 63/689,903, filed on Sep. 3, 2024, the entirety of which is incorporated by reference herein.

This application claims the benefit of U.S. Provisional Application No. 63/698,640, filed on Sep. 25, 2024, the entirety of which is incorporated by reference herein.

This application claims priority of Taiwan Patent Application No. 114120228, filed on May 29, 2025, the entirety of which is incorporated by reference herein.

### BACKGROUND OF THE INVENTION

### Field of the Invention

The disclosure is generally related to a resonant power conversion circuit, and more particularly it is related to a resonant power conversion circuit controlled by the integral result of the feedback signal.

### Description of the Related Art

Portable electronic devices are undergoing continuous development, especially in the field of power conversion circuits, with the trend being towards high efficiency, high power density, high reliability, and low cost. Since resonant power conversion circuits (such as LLC resonant power conversion circuits) have certain advantages, including the capability to achieve zero-voltage switching (ZVS) on the primary side and zero-current switching (ZCS) of the rectification diode on the secondary side within the full load range. Further advantages include using frequency control to make sure that the duty cycles of the high-side transistor and the low-side transistor are both 50%; ensuring that no output inductor is required; and adapting lower voltage transistors on the secondary side to reduce costs and improve efficiency. As a result, they have increasingly been used in DC voltage converters in recent years.

### BRIEF SUMMARY OF THE INVENTION

The resonant power conversion circuit proposed in the present invention tracks the integration of the feedback signal with the integration of the current flowing through the resonant capacitor, which is beneficial to more precise control of the input power and the output power, and a slope compensation signal is added to eliminate the negative impact caused by the right half-plane zero. In addition, the integration of the current of the resonant capacitor can be replaced by the voltage across the resonant capacitor, which can also accurately control the input power and output power.

In an embodiment, a power conversion circuit for converting an input voltage to an output voltage is provided. The power conversion circuit comprises a transformer, a resonant capacitor, a high-side transistor, a low-side transistor, a current detection circuit, a feedback circuit, and a control circuit. The transformer comprises a primary coil and a secondary coil, wherein the primary coil is coupled between a switch node and a resonant node. The resonant capacitor is coupled between the resonant node and a ground. The high-side transistor provides the input voltage to the switch node based on a high-side driving signal. The low-side transistor couples the switch node to the ground based on a low-side driving signal. The current detection circuit detects a resonant current flowing through the resonant capacitor to generate a current detection signal. The feedback circuit generates a feedback signal based on the output voltage. The control circuit superpositions the current detection signal to a slope compensation signal to generate a superposition signal and integrates the superposition signal to generate a first integral signal. The control circuit further integrates the feedback signal to generate a second integral signal and compares the first integral signal and the second integral signal to generate the high-side driving signal and the low-side driving signal.

According to an embodiment of the present invention, the slope compensation signal is a sawtooth wave.

According to an embodiment of the present invention, the second integral signal is a product of the feedback signal and an on-time. The on-time is one of an on-time of the high-side transistor, an on-time of the low-side transistor, and a switching period. The high-side driving signal and the low-side driving signal have the switching period.

According to an embodiment of the present invention, when the high-side transistor is turned on, the second integral signal is a product of the feedback signal and the on-time of the high-side transistor in a previous conduction period. When the low-side transistor is turned on, the second integral signal is a product of the feedback signal and the on-time of the low-side transistor in previous conduction period.

According to an embodiment of the present invention, when the high-side transistor or the low-side transistor is turned on, the second integral signal is a product of the feedback signal and the switching period.

According to an embodiment of the present invention, the control circuit further comprises a superposition circuit and a first integral circuit. The superposition circuit superpositions the current detection signal to the slope compensation signal to generate the superposition signal. The first integral circuit integrates the superposition signal to generate the first integral signal. When the high-side transistor is turned on, the superposition circuit adds the slope compensation signal to the current detection signal to generate the superposition signal. When the low-side transistor is turned on, the superposition circuit subtracts the slope compensation signal from the current detection signal to generate the superposition signal.

According to an embodiment of the present invention, the control circuit further comprises a full-wave rectification device and a comparator. The full-wave rectification device full-wave rectifies the first integral signal to generate a full-wave rectification signal. The comparator compares the full-wave rectification signal and the second integral signal. When the full-wave rectification signal exceeds the second integral signal, the control circuit turns off the high-side transistor or turns off the low-side transistor.

According to an embodiment of the present invention, when the high-side transistor is turned on and the full-wave rectification signal drops to not exceeding the second integral signal, the control circuit turns off the high-side transistor. When the low-side transistor is turned on and the full-wave rectification signal drops to not exceeding the second integral signal, the control circuit turns off the low-side transistor.

According to an embodiment of the present invention, the control circuit further comprises a first error amplifier, a second error amplifier, a first comparator, and a second comparator. The first error amplifier compares the second integral signal and a reference voltage to generate an upper limit voltage. The second error amplifier compares the reference voltage and the second integral signal to generate a low limit voltage. The first comparator compares the first integral signal and the upper limit voltage to disable the high-side driving signal. The second comparator compares the first integral signal and the lower limit voltage to disable the low-side driving signal. When the high-side transistor is turned on and the first integral signal exceeds the upper limit voltage, the first comparator disables the high-side driving signal. When the low-side transistor is turned on and the lower limit voltage exceeds the first integral signal, the second comparator disables the low-side driving signal.

According to an embodiment of the present invention, when the high-side transistor is turned on and the first integral signal drops to not exceeding the upper limit voltage, the control circuit turns off the high-side transistor. When the low-side transistor is turned on and the first integral signal rises to exceeding the lower limit voltage, the control circuit turns off the low-side transistor.

According to an embodiment of the present invention, the control circuit controls the first integral signal to track the second integral signal, thereby controlling the power conversion circuit to receive input power from the input voltage and to generate output power of the output voltage.

According to an embodiment of the present invention, on-time of the high-side transistor is equal to on-time of the low-side transistor.

According to an embodiment of the present invention, the power conversion circuit further comprises a rectification circuit. The rectification circuit is coupled to the secondary coil. The rectification circuit is configured to convert energy of the secondary coil into the output voltage.

In another embodiment, a power conversion circuit for converting an input voltage into an output voltage is provided. The power conversion circuit comprises a transformer, a resonant capacitor, a high-side transistor, a low-side transistor, a voltage detection circuit, a feedback circuit, and a control circuit. The transformer comprises a primary coil and a secondary coil, where the primary coil is coupled between a switch node and a resonant node. The resonant capacitor is coupled between the resonant node and a ground. The high-side transistor provides the input voltage to the switch node based on a high-side driving signal. The low-side transistor couples the switch node to the ground based on a low-side driving signal. The voltage detection circuit detects a voltage across the resonant capacitor to generate a voltage detection signal. The feedback circuit generates a feedback signal based on the output voltage. The control circuit superpositions the voltage detection signal to a slope compensation signal to generate a superposition signal and integrates the feedback signal to generate an integral signal. The control circuit further compares the integral signal and the superposition signal to generate the high-side driving signal and the low-side driving signal.

According to an embodiment of the present invention, the slope compensation signal is an integration of a sawtooth wave over time.

According to an embodiment of the present invention, the slope compensation signal is a parabolic wave.

According to an embodiment of the present invention, the integral signal is a product of the feedback signal and an on-time. The on-time is one of an on-time of the high-side transistor, an on-time of the low-side transistor, and a switching period. The high-side driving signal and the low-side driving signal have the switching period.

According to an embodiment of the present invention, when the high-side transistor is turned on, the integral signal is a product of the feedback signal and the on-time of the high-side transistor in a previous conduction period. When the low-side transistor is turned on, the integral signal is a product of the feedback signal and the on-time of the low-side transistor in a previous conduction period.

According to an embodiment of the present invention, when the high-side transistor or the low-side transistor is turned on, the integral signal is a product of the feedback signal and the switching period.

According to an embodiment of the present invention, the control circuit further comprises a superposition circuit. The superposition circuit superpositions the current detection signal to the slope compensation signal to generate the superposition signal. When the high-side transistor is turned on, the superposition circuit adds the slope compensation signal to the current detection signal to generate the superposition signal. When the low-side transistor is turned on, the superposition circuit subtracts the slope compensation signal from the current detection signal to generate the superposition signal.

According to an embodiment of the present invention, the voltage detection circuit comprises a voltage divider. The voltage divider divides a voltage across the resonant capacitor to generate the voltage detection signal.

According to an embodiment of the present invention, the control circuit further comprises a full-wave rectification device and a comparator. The full-wave rectification device full-wave rectifies the superposition signal to generate a full-wave rectification signal. The comparator compares the full-wave rectification signal and the integral signal. When the full-wave rectification signal exceeds the integral signal, the control circuit turns off the high-side transistor or turns off the low-side transistor.

According to an embodiment of the present invention, when the high-side transistor is turned on and the full-wave rectification signal drops to not exceeding the integral signal, the control circuit turns off the high-side transistor. When the low-side transistor is turned on and the full-wave rectification signal drops to not exceeding the integral signal, the control circuit turns off the low-side transistor.

According to an embodiment of the present invention, the control circuit further comprises a first error amplifier, a second error amplifier, a first comparator, and a second comparator. The first error amplifier compares the integral signal and a reference voltage to generate an upper limit voltage. The second error amplifier compares the reference voltage and the integral signal to generate a low limit voltage. The first comparator compares the superposition signal and the upper limit voltage to disable the high-side driving signal. The second comparator compares the superposition signal and the lower limit voltage to disable the low-side driving signal. When the high-side transistor is turned on and the superposition signal exceeds the upper limit voltage, the first comparator disables the high-side driving signal. When the low-side transistor is turned on and the lower limit voltage exceeds the superposition signal, the second comparator disables the low-side driving signal.

According to an embodiment of the present invention, when the high-side transistor is turned on and the superposition signal drops to not exceeding the upper limit voltage, the control circuit turns off the high-side transistor. When the low-side transistor is turned on and the superposition signal rises to exceeding the lower limit voltage, the control circuit turns off the low-side transistor.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of the power conversion circuit in accordance with an embodiment of the present invention;

FIG. 2 shows a waveform diagram of the power conversion circuit in accordance with an embodiment of the present invention;

FIG. 3 shows a block diagram of the power conversion circuit in accordance with another embodiment of the present invention;

FIG. 4 is a block diagram showing a power conversion circuit in accordance with another embodiment of the present invention;

FIG. 5 shows a block diagram of a power conversion circuit in accordance with another embodiment of the present invention; and

FIG. 6 shows a block diagram of the power conversion circuit in accordance with another embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

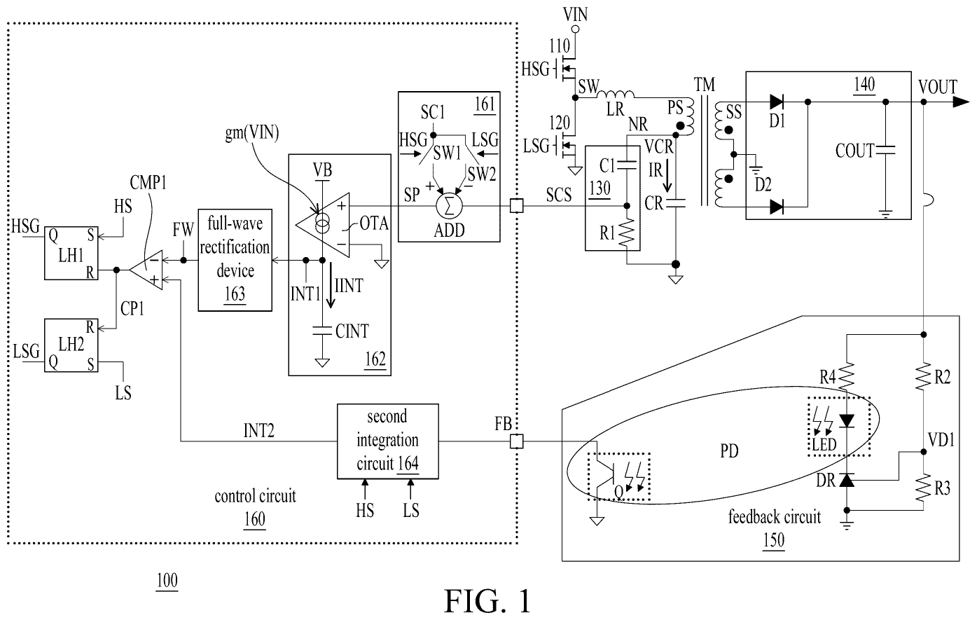

FIG. 1 shows a block diagram of the power conversion circuit in accordance with an embodiment of the present invention. As shown in the first figure, the power conversion circuit 100 includes a transformer TM, a resonant inductor LR, a resonant capacitor CR, a high-side transistor 110, a low-side transistor 120, a current detection circuit 130, a rectification circuit 140, a feedback circuit 150, and a control circuit 160.

The transformer TM includes a primary coil PS and a secondary coil SS, where the primary coil PS is coupled to the resonant node NR. The resonant inductor LR is coupled between the switch node SW and the primary coil PS, and the resonant capacitor CR is coupled to the resonant node NR and the ground. According to an embodiment of the present invention, the resonant inductance LR may be replaced by the leakage inductance of the primary coil PS of the transformer TM. In other words, the primary coil PS may be coupled between the switch node SW and the resonant node NR.

According to some embodiments of the present invention, the power conversion circuit 100 is a resonant power conversion circuit. According to an embodiment of the present invention, the power conversion circuit 100 may be an LLC resonant power conversion circuit. According to another embodiment of the present invention, the power conversion circuit 100 may also be an Asymmetric Half-Bridge (AHB) flyback converter.

The high-side gate driving signal HSG turns on and off the high-side transistor 110 to provide the input voltage VIN to the switch node SW. The low-side gate driving signal LSG turns on and off the low-side transistor 120 to couple the switch node SW to the ground. The current detection circuit 130 is coupled to the resonant node NR to detect the resonant current IR flowing through the resonant capacitor CR to generate the current detection signal SCS. The current detection circuit 130 includes a first capacitor C1 and a first resistor R1. The first capacitor C1 is coupled to the resonant node NR, and the first resistor R1 is coupled between the first capacitor C1 and the ground, where a current detection signal SCS is generated between the first capacitor C1 and the first resistor R1. In other words, the current detection signal SCS is a voltage across the first resistor R1.

The rectification circuit 140 is coupled to the secondary coil SS to convert the energy of the secondary line source SS into an output voltage VOUT. In other words, the rectification circuit 140 is configured to convert the current flowing through the secondary coil SS into an output voltage VOUT. As shown in FIG. 1, the rectification circuit 140 includes a first rectification element D1, a second rectification element D2, and an output capacitor COUT.

The first rectification element D1 and the second rectification element D2 are configured to charge the output capacitor COUT more efficiently by the current flowing through the secondary coil SS, thereby generating an output voltage VOUT. According to other embodiments of the present invention, the first rectification element D1 and the second rectification element D2 may be replaced with electronic components with low on-resistance to further improve the conversion efficiency.

The feedback circuit 150 generates a feedback signal FB based on the output voltage VOUT. As shown in FIG. 1, the feedback circuit 150 includes a second resistor R2, a third resistor R3, a voltage regulation element DR, an optical coupling element PD, and a fourth resistor R4. The second resistor R2 and the third resistor R3 are configured to divide the output voltage VOUT to generate the first divided voltage VD1. The voltage regulation element DR generates a current flowing through the diode LED of the optical coupling element PD to emit light based on the first voltage divider voltage VD1, and the transistor Q of the optical coupling element PD is turned on by optical coupling, thereby generating a feedback signal FB.

The fourth resistor R4 is configured to limit the current flowing through the diode LED. According to an embodiment of the present invention, the voltage regulation element DR may be TL431. According to an embodiment of the present invention, when the output voltage VOUT increases, the feedback signal FB decreases accordingly. According to another embodiment of the present invention, when the output voltage VOUT decreases, the feedback signal FB increases accordingly. According to an embodiment of the present invention, when the output power of the output voltage VOUT increases, the feedback signal FB increases accordingly. According to another embodiment of the present invention, when the output power of the output voltage VOUT decreases, the feedback signal FB decreases accordingly.

The control circuit 160 generates the high-side gate driving signal HSG and the low-side gate driving signal LSG based on the current detection signal SCS and the feedback signal FB. As shown in FIG. 1, the control circuit 160 includes a first superposition circuit 161, a first integration circuit 162, a full-wave rectification device 163, a second integration circuit 164, a first comparator CMP1, a first latch LH1, and a second latch LH2.

The first superposition circuit 161 is configured to superposition the current detection signal SCS to the first slope compensation signal SC1 to generate the superposition signal SP. According to some embodiments of the present invention, the first slope compensation signal SC1 is configured to eliminate the negative impact of the right half-plane zero point. According to an embodiment of the present invention, the first slope compensation signal SC1 is a sawtooth wave. In other words, the first slope compensation signal SC1 is a result obtained by integrating a constant against time. As shown in FIG. 1, the first superposition circuit 161 includes a first switch SW1, a second switch SW2, and an addition circuit ADD.

According to an embodiment of the present invention, when the high-side gate driving signal HSG turns on the high-side transistor 110, the first switch SW1 is turned on, and the addition circuit ADD adds the current detection signal SCS to the first slope compensation signal SC1, thereby generating the superposition signal SP. According to another embodiment of the present invention, when the low-side gate driving signal LSG turns on the low-side transistor 120, the second switch SW2 is turned on and the addition circuit ADD subtracts the first slope compensation signal SC1 from the current detection signal SCS to generate the superposition signal SP.

The first integration circuit 162 is configured to integrate the superposition signal SP to generate the first integration signal INT1. As shown in FIG. 1, the first integration circuit 162 includes a transconductance amplifier OTA and an integration capacitor CINT. The transconductance amplifier OTA is powered by the bias voltage VB and generates an integral current IINT based on the superposition signal SP. The integral current IINT charges the integral capacitor CINT to generate the first integral signal INT1. According to an embodiment of the present invention, the transconductance gm generated by the transconductance amplifier OTA is proportional to the input voltage VIN.

The full-wave rectification device 163 is configured to perform full-wave rectification on the first integral signal INT1 to generate a full-wave rectification signal FW. The second integration circuit 164 integrates the feedback signal FB based on the high-side driving signal HS and the low-side driving signal LS to generate the second integration signal INT2. The first comparator CMP1 compares the full-wave rectification signal FW and the second integral signal INT2 to generate the first comparison signal CP1.

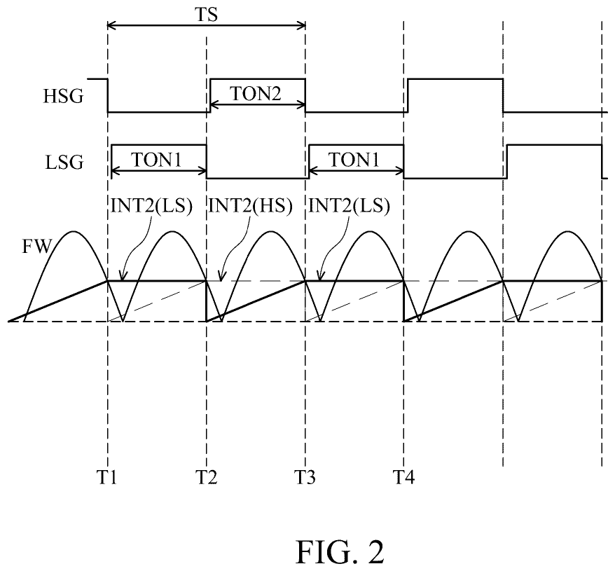

According to an embodiment of the present invention, when the full-wave rectification signal FW exceeds the second integral signal INT2, the first comparison signal CP1 is disabled. According to another embodiment of the present invention, when the full-wave rectification signal FW does not exceed the second integral signal INT2, the first comparison signal CP1 is enabled. How the second integration circuit 164 generates the second integration signal INT2 based on the high-side driving signal HS and the low-side driving signal LS will be further described in the following paragraphs regarding FIG. 2.

The first latch LH1 enables the high-side gate driving signal HSG based on the high-side driving signal HS being enabled, and disables the high-side gate driving signal HSG based on the rising edge of the first comparison signal CP1. The second latch LH2 enables the low-side gate driving signal LSG based on the low-side driving signal LS being enabled, and disables the low-side gate driving signal LSG based on the rising edge of the first comparison signal CP1.

According to some embodiments of the present invention, when the high-side gate driving signal HSG or the low-side gate driving signal LSG is enabled, the high-side transistor 110 or the low-side transistor 120 is turned on. According to other embodiments of the present invention, when the high-side gate driving signal HSG or the low-side gate driving signal LSG is disabled, the high-side transistor 110 or the low-side transistor 120 is turned off.

FIG. 2 shows a waveform diagram of the power conversion circuit in accordance with an embodiment of the present invention. The following description of the waveform diagram of FIG. 2 will be combined with the power conversion circuit 100 of FIG. 1 for detailed explanation. From the first time point T1 to the second time point T2, the low-side gate driving signal LSG is enabled to turn on the low-side transistor 120, and the second integration circuit 164 generates the second integration signal INT2 (i.e., INT2 (LS) shown in FIG. 2) based on the low-side driving signal LS being enabled.

When the full-wave rectification signal FW drops and does not exceed the second integral signal INT2 (i.e., INT2 (LS) shown in FIG. 2), the rising edge of the first comparison signal CP1 disables the low-side gate driving signal LSG to turn off the low-side transistor 120. In detail, when the first comparison signal CP1 transitions from the disabled state to the enabled state (i.e., the full-wave rectification signal FW drops from exceeding the second integral signal INT2 to not exceeding the second integral signal INT2), the second latch LH2 disables the low-side gate driving signal LSG and turns off the low-side transistor 120. According to an embodiment of the present invention, the first on-time TON1 is the on-time of the low-side transistor 120.

From the second time point T2 to the third time point T3, the high-side gate driving signal HSG is enabled to turn on the high-side transistor 110, and the second integration circuit 164 generates the second integration signal INT2 (i.e., INT2 (HS) shown in FIG. 2) based on the enabled high-side driving signal HS. When the full-wave rectification signal FW drops and does not exceed the second integral signal INT2 (i.e., INT2 (HS) shown in FIG. 2) at the third time point T3, the rising edge of the first comparison signal CP1 disables the high-side gate driving signal HSG to turn off the high-side transistor 110. In detail, when the first comparison signal CP1 transitions from the disable state to the enable state (i.e., the full-wave rectification signal FW drops from exceeding the second integral signal INT2 to not exceeding the second integral signal INT2), the first latch LH1 disables the high-side gate driving signal HSG to turn off the high-side transistor 110.

According to an embodiment of the present invention, the second on-time TON2 is the on-time of the high-side transistor 110. According to some embodiments of the present invention, the first on-time TON1 may be equal to the second on-time TON2. According to other embodiments of the present invention, the first on-time TON1 may not be equal to the second on-time TON2. According to some embodiments of the present invention, the second integral signal INT2 is the product of the feedback signal FB and the previous on-time.

For example, the second integral signal INT2 (i.e., INT2 (HS) shown in FIG. 2) from the second time point T2 to the third time point T3 is the product of the feedback signal FB and the first on-time TON1 from the first time point T1 to the second time point T2. The second integral signal INT2 (i.e., INT2 (LS) shown in FIG. 2) from the third time point T3 to the fourth time point T4 is the product of the feedback signal FB and the second on-time TON2 from the second time point T2 to the third time point T3.

In other words, when the high-side transistor 110 is turned on from the second time point T2 to the third time point T3, the second integral signal INT2 is the product of the feedback signal FB and the on-time of the low-side transistor 120 from the first time point T1 to the second time point T2 (i.e., the first on-time TON1). When the low-side transistor 120 is turned on from the third time point T3 to the fourth time point T4, the second integral signal INT2 is the product of the feedback signal FB and the on-time of the high-side transistor 110 from the second time point T2 to the third time point T3 (i.e., the second on-time TON2).

In addition, as shown in the embodiment of FIG. 2, the second integral signal INT2 corresponding to the high-side transistor 110 being turned on (i.e., INT2 (HS) shown in FIG. 2) is constantly increasing when the low-side transistor 120 is turned on, and reaches a maximum value when the low-side transistor 120 is turned off. Similarly, the second integral signal INT2 corresponding to the low-side transistor 120 being turned on (i.e., INT2 (LS) shown in FIG. 2) increases continuously when the high-side transistor 110 is turned on, and reaches a maximum value when the high-side transistor 110 is turned off.

In the embodiment of FIG. 2 of the present invention, since the first on-time TON1 is equal to the second on-time TON2, the second integral signal INT2 is almost a fixed value (that is, INT2 (LS) shown in FIG. 2 is equal to INT2 (HS)). According to other embodiments of the present invention, when the first on-time TON1 and the second on-time TON2 are different, the second integral signal INT2 corresponding to the high-side transistor 110 being turned on and the second integral signal INT2 corresponding to the low-side transistor 120 being turned on are not the same.

According to other embodiments of the present invention, the second integral signal INT2 may also be the product of the feedback signal FB and the switching period TS, so that the second integral signal INT2 corresponding to the conduction of the high-side transistor 110 and the second integral signal INT2 corresponding to the conduction of the low-side transistor 120 are the same. In other words, when the second integral signal INT2 is the product of the feedback signal FB and the switching period TS, the second integral circuit 164 no longer generates the corresponding second integral signal INT2 based on the high-side driving signal HS and the low-side driving signal LS, and the second integral signal INT2 in FIG. 2 is a constant value.

In the power conversion circuit 100, the input power PIN of the input voltage VIN is the product of the input voltage VIN and the average current IAV from the input voltage VIN flowing through the high-side transistor 110, as shown in Eq. 1.

$$PIN = VIN \times IAV \qquad ( Eq . 1 )$$

The average current IAV can be replaced by the product of the resonant capacitor CR, the variation ΔVCR of the resonant voltage VCR, and the switching frequency FS, where the switching frequency FS is the switching frequency of the high-side driving signal HS and the low-side driving signal LS, and the switching frequency FS is an inverse of the switching period TS in FIG. 2, which is shown in Eq. 2.

$$PIN = VIN \times CR \times Δ VCR \times FS \qquad ( Eq . 2 )$$

According to some embodiments of the present invention, the variation ΔVCR tracking feedback signal FB may be used as an indicator for monitoring the input power PIN. However, in the embodiment of the power conversion circuit 100 in FIG. 1, the switching frequency FS changes with the output voltage VOUT, and if only the variation ΔVCR is controlled, the impact of the switching frequency FS on the input power PIN is ignored. In addition, the product of the resonant capacitor CR and the variation ΔVCR is equal to the integration of the resonant current IR over time, so the input power PIN of Eq. 2 can be rewritten to Eq. 3.

$$PIN = VIN \times \int ( IR ) dt \times FS \qquad ( Eq . 3 )$$

In the embodiment of FIG. 1, the first comparator CMP1 controls the integration of the resonant current IR to track the integration of the feedback signal FB, so that the switching frequency FS in Eq. 3 is eliminated. As shown in FIG. 1, the transconductance gm of the transconductance amplifier OTA charges the integral capacitor CINT based on the current detection signal SCS, which can be expressed as the left side of the equal sign of Eq. 4. The right side of the equal sign of Eq. 4 is the second integral circuit 164 integrating the feedback signal FB, and the second integral signal INT2 can be represented as the product of the feedback signal FB and the on-time TON, where the on-time TON corresponds to the first on-time TON1 or the second on-time TON2 in FIG. 2. According to other embodiments of the present invention, the on-time TON may also be the switching period TS in FIG. 2, where the switching period TS is an inverse of the switching frequency FS.

$$\frac{gm \times \int ( SCS ) dt}{CINT} = \int ( FB ) dt = FB \times TON \qquad ( Eq . 4 )$$

The integration of the current detection signal SCS can be expressed by Eq. 5.

$$\int ( SCS ) dt = \frac{CINT \times FB \times TON}{gm} \qquad ( Eq . 5 )$$

Since the current detection signal SCS is configured to represent the resonant current IR, the integration of the resonant current IR can be represented by Eq. 6.

$$\int ( IR ) dt = \frac{C 1 + CR}{C 1} \times \frac{1}{R 1} \times \int ( SCS ) dt = \frac{C 1 + CR}{C 1} \times \frac{CINT \times FB \times TON}{gm \times R 1} \qquad ( Eq . 6 )$$

Eq. 6 is substituted into Eq. 3 to get Eq. 7.

$$\begin{matrix}PIN = VIN \times \int ( IR ) dt \times FS \\ = VIN \times ( \frac{C 1 + CR}{C 1} \times \frac{CINT \times FB \times TON}{gm \times R 1} ) \times FS\end{matrix} \qquad ( Eq . 7 )$$

As shown in the embodiment of FIG. 2, the first on-time TON1 and the second on-time TON2 are equal, so the on-time TON of Eq. 7 is about half of the switching period TS. In other words, the product of TON and FS in Eq. 7 is about 0.5. Therefore, Eq. 7 can be rewritten to Eq. 8.

$$PIN ∼ 0.5 \times VIN \times ( \frac{CINT \times FB}{gm \times R 1} \times \frac{C 1 + CR}{C 1} ) \qquad ( Eq . 8 )$$

According to an embodiment of the present invention, the transconductance gm generated by the transconductance amplifier OTA is proportional to the input voltage VIN. In other words, transconductance gm can be expressed as the product of the constant k and the input voltage VIN, and the product of the constant k and the input voltage VIN is replaced by gm of Eq. 8 and rewritten as Eq. 9.

$$PIN ∼ 0.5 \times ( \frac{CINT \times FB}{k \times R 1} \times \frac{C 1 + CR}{C 1} ) \qquad ( Eq . 9 )$$

As shown in Eq. 9, the input power PIN is only related to the feedback signal FB. In other words, the feedback signal FB is not only an indicator of the output power of the power conversion circuit 100, but also an indicator of the input power PIN of the power conversion circuit 100. Specifically, the power conversion circuit 100 of FIG. 1 drives the high-side transistor 110 and the low-side transistor 120 using the first integral signal INT1 and the second integral signal INT2, which is benefit to simultaneously controlling the input power of the input voltage VIN and the output power of the output voltage VOUT.

According to some embodiments of the present invention, the second integral signal INT2 may be a DC voltage value. According to some embodiments of the present invention, the control method of integrating the current detection signal and integrating the feedback signal utilized by the power conversion circuit 100 of FIG. 1 is similar to a control method of Peak Current Mode.

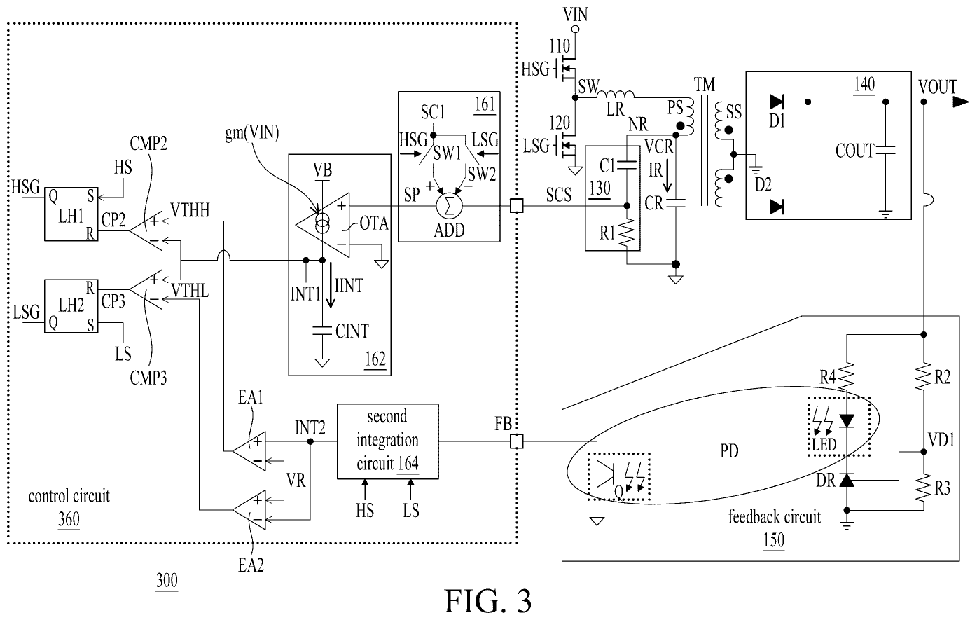

FIG. 3 shows a block diagram of the power conversion circuit in accordance with another embodiment of the present invention. Compared the control circuit 360 of the power conversion circuit 300 in FIG. 3 with the control circuit 160 in FIG. 1, the full-wave rectification device 163 and the first comparator CMP1 of the control circuit 160 are replaced by the first error amplifier EA1, the second error amplifier EA2, the second comparator CMP2, and the third comparator CMP3 of the control circuit 360.

As shown in FIG. 3, the first error amplifier EA1 generates the upper limit voltage VTHH based on the difference between the second integral signal INT2 and the reference voltage VR. The second error amplifier EA2 generates a lower limit voltage VTHL based on the difference between the reference voltage VR and the second integral signal INT2. According to some embodiments of the present invention, the reference voltage VR may be adjusted to adjust the proportion of the on-time of the high-side transistor 110 and the on-time of the low-side transistor 120. The second comparator CMP2 compares the upper limit voltage VTHH and the first integral signal INT1 to generate the second comparison signal CP2. The third comparator CMP3 compares the first integral signal INT1 and the lower limit voltage VTHL to generate the third comparison signal CP3.

According to an embodiment of the present invention, when the high-side gate driving signal HSG turns on the high-side transistor 110 and the first integration signal INT1 drops to not exceeding the upper limit voltage VTHH, the first latch LH1 disables the high-side gate driving signal HSG to turn off the high-side transistor 110. Specifically, when the high-side transistor 110 is turned on and the first integral signal INT1 drops from exceeding the upper limit voltage VTHH to not exceeding the upper limit voltage VTHH, the control circuit 360 turns off the high-side transistor 110.

According to another embodiment of the present invention, when the low-side gate driving signal LSG turns on the low-side transistor 120 and the first integration signal INT1 rises to exceeding the lower limit voltage VTHL, the second latch LH2 disables the low-side gate driving signal LSG to turn off the low-side transistor 120. Specifically, when the low-side transistor 120 is turned on and the first integral signal INT1 rises from not exceeding the lower limit voltage VTHL to exceeding the lower limit voltage VTHL, the control circuit 360 turns off the low-side transistor 120.

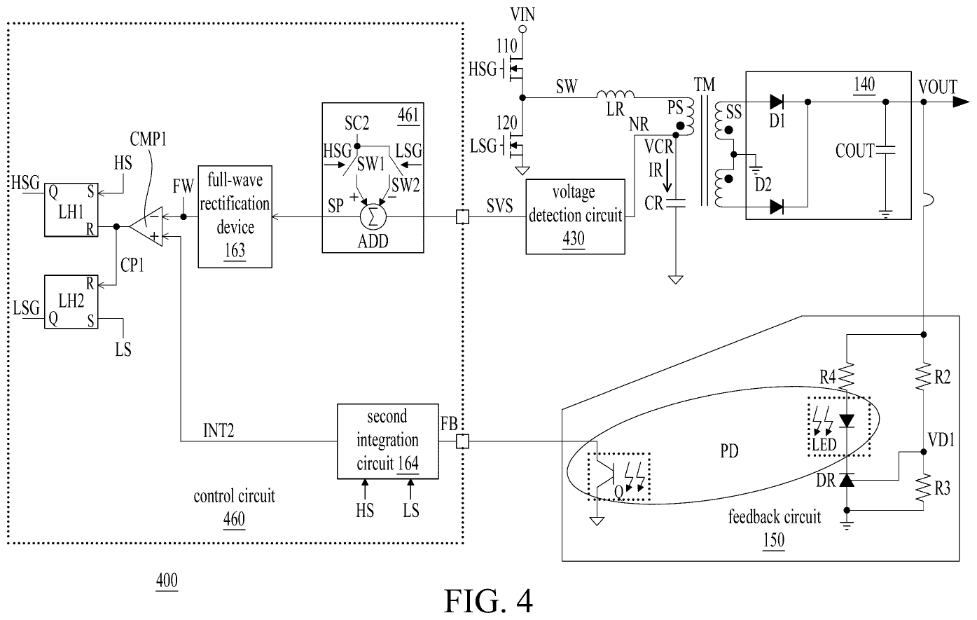

FIG. 4 is a block diagram showing a power conversion circuit in accordance with another embodiment of the present invention. Compared the power conversion circuit 400 in FIG. 4 to the power conversion circuit 100 in FIG. 1, the current detection circuit 130 of the power conversion circuit 100 is replaced by a voltage detection circuit 430, the first superposition circuit 161 of the control circuit 160 is replaced by a second superposition circuit 461, and the first integration circuit 162 is omitted.

As shown in FIG. 4, the voltage detection circuit 430 is coupled to the resonant node NR, and generates a voltage detection signal SVS based on the resonant voltage VCR. According to an embodiment of the present invention, the voltage detection circuit 430 may include a voltage divider, where the voltage divider is configured to divide the resonant voltage VCR to generate a voltage detection signal SVS. In other words, the resonant voltage VCR multiplied by the voltage dividing ratio is equal to the voltage detection signal SVS.

The second superposition circuit 461 is configured to superposition the second slope compensation signal SC2 to the voltage detection signal SVS to generate the superposition signal SP. According to an embodiment of the present invention, the second slope compensation signal SC2 is integration of the first slope compensation signal SC1. Specifically, the first slope compensation signal SC1 is a sawtooth wave, and generates a parabolic wave is generated after the sawtooth wave integrating over time. In other words, the second slope compensation signal SC2 is a result of the integration of the first slope compensation signal SC1 over time. That is, the second slope compensation signal SC2 is a parabolic wave.

Since the integration of the current signal over time is equivalent to the voltage signal, and the integration of the first slope compensation signal SC1 over time is equivalent to the second slope compensation signal SC2, integration of the current detection signal SCS plus the first slope compensation signal SC1 as shown in in FIG. 1 is equivalent to the voltage detection signal SVS plus the second slope compensation signal SC2. In other words, the full-wave rectification signal FW of the power conversion circuit 400 is equivalent to the full-wave rectification signal FW of the power conversion circuit 100.

According to an embodiment of the present invention, when the high-side transistor 110 is turned on and the full-wave rectification signal FW drops to not exceeding the second integral signal INT2, the first latch LTH1 disables the high-side gate driving signal HSG to turn off the high-side transistor 110. According to another embodiment of the present invention, when the low-side transistor 120 is turned on and the full-wave rectified signal FW drops to not exceeding the second integral signal INT2, the second latch LTH2 disables the low-side gate driving signal LSG to turn off the low-side transistor 120.

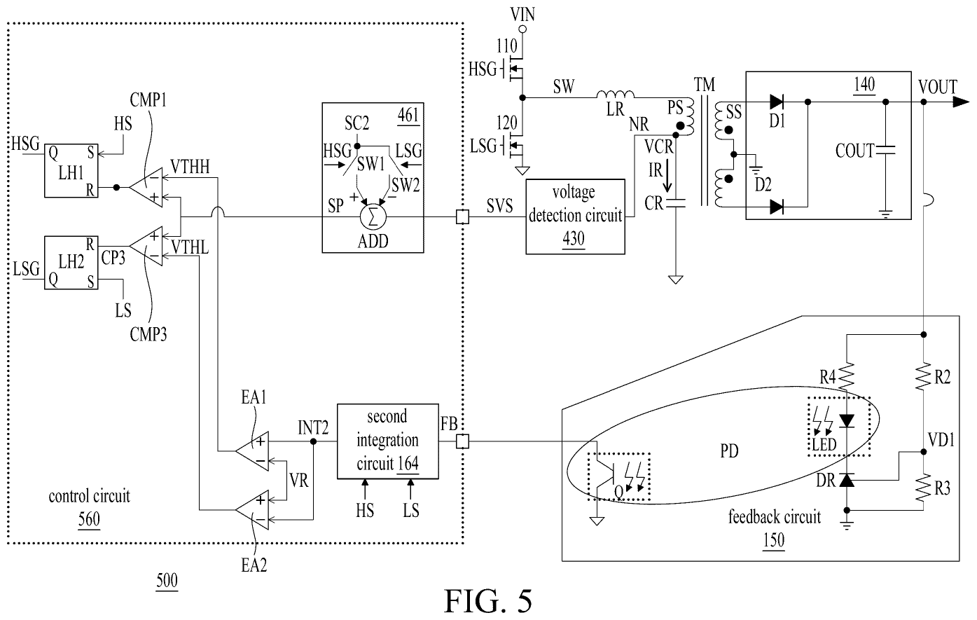

FIG. 5 shows a block diagram of a power conversion circuit in accordance with another embodiment of the present invention. Compared the control circuit 560 of the power conversion circuit 500 in FIG. 5 to the control circuit 460 in FIG. 4, the full-wave rectification device 163 and the first comparator CMP1 of the control circuit 460 are replaced by the first error amplifier EA1, the second error amplifier EA2, the second comparator CMP2, and the third comparator CMP3 of the power conversion circuit 500.

As shown in FIG. 5, the first error amplifier EA1 generates the upper limit voltage VTHH based on the difference between the second integral signal INT2 and the reference voltage VR. The second error amplifier EA2 generates a lower limit voltage VTHL based on the difference between the reference voltage VR and the second integral signal INT2. According to some embodiments of the present invention, the reference voltage VR may be adjusted to adjust the duty cycle of the on-time of the high-side transistor 110 to the on-time of the low-side transistor 120. The second comparator CMP2 compares the upper limit voltage VTHH and the superposition signal SP to generate the second comparison signal CP2. The third comparator CMP3 compares the superposition signal SP and the lower limit voltage VTHL to generate the third comparison signal CP3.

According to an embodiment of the present invention, when the high-side gate driving signal HSG turns on the high-side transistor 110 and the superposition signal SP drops to not exceeding the upper limit voltage VTHH, the first latch LH1 disables the high-side gate driving signal HSG to turn off the high-side transistor 110. Specifically, when the high-side transistor 110 is turned on and the superposition signal SP from exceeding the upper limit voltage VTHH drops to not exceeding the upper limit voltage VTHH, the control circuit 560 turns off the high-side transistor 110.

According to another embodiment of the present invention, when the low-side gate driving signal LSG turns on the low-side transistor 120 and the superposition signal SP rises to exceeding the lower limit voltage VTHL, the second latch LH2 disables the low-side gate driving signal LSG to turn off the low-side transistor 120. Specifically, when the low-side transistor 120 is turned on and the first integral signal INT1 rises from not exceeding the lower limit voltage VTHL to exceeding the lower limit voltage VTHL, the control circuit 360 turns off the low-side transistor 120.

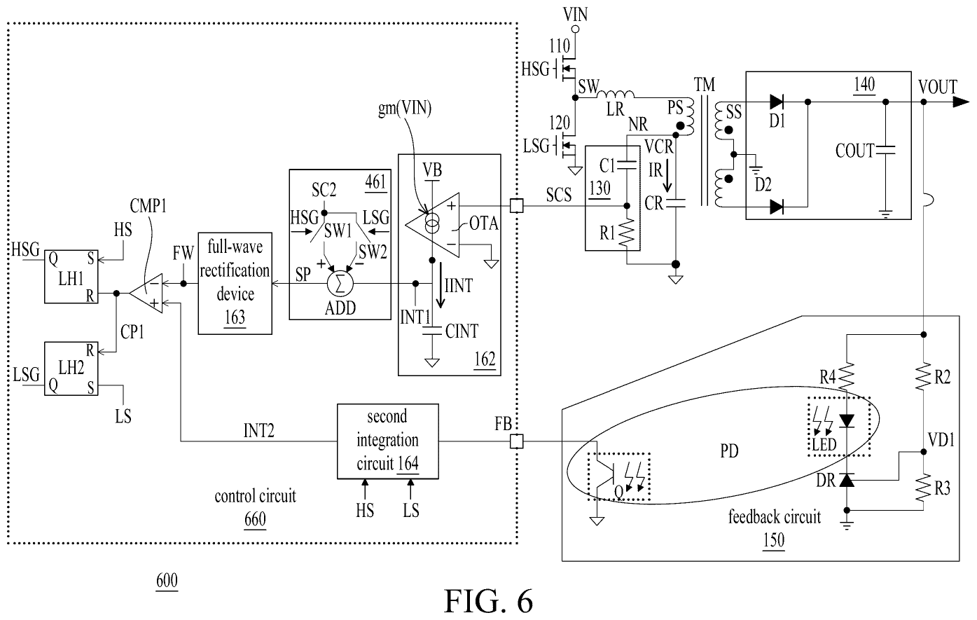

FIG. 6 shows a block diagram of the power conversion circuit in accordance with another embodiment of the present invention. Compared the power conversion circuit 600 of FIG. 6 with the power conversion circuit 100 of FIG. 1, the power conversion circuit 600 replaces the first superposition circuit 161 of FIG. 1 with the second superposition circuit 461 of FIG. 1. As shown in FIG. 6, the second superposition circuit 461 is located between the first integration circuit 162 and the full-wave rectification device 163, and the second superposition circuit 461 is configured to superposition the second slope compensation signal SC2 to the integration of the current detection signal SCS.

As shown in FIG. 1, the signal received by the full-wave rectification device 163 of the power conversion circuit 100 is an integration of the current detection signal SCS superpositioning the first slope compensation signal SC1. Since the second slope compensation signal SC2 is an integration of the first slope compensation signal SC1, the signal received by the full-wave rectification device 163 in FIG. 1 is equivalent to the integration of the current detection signal SCS plus the second slope compensation signal SC2.

As shown in FIG. 6, the signal received by the full-wave rectification device 163 of the power conversion circuit 600 is also the second slope compensation signal SC2 plus an integration of the current detection signal SCS (i.e., the first integral signal INT1 of FIG. 6). In other words, the power conversion circuit 100 and the full-wave rectification device 163 of the power conversion circuit 600 receive the same signal, so the full-wave rectification signal FW generated by the power conversion circuit 100 and the power conversion circuit 600 are also the same.

The resonant power conversion circuit proposed in the present invention tracks the integration of the feedback signal with the integration of the current flowing through the resonant capacitor, which is beneficial to more precise control of the input power and the output power, and a slope compensation signal is added to eliminate the negative impact caused by the right half-plane zero. In addition, the integration of the current of the resonant capacitor can be replaced by the voltage across the resonant capacitor, which can also accurately control the input power and output power.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit for converting an input voltage to an output voltage, comprising:
a transformer, comprising a primary coil and a secondary coil, wherein the primary coil is coupled between a switch node and a resonant node;
a resonant capacitor, coupled between the resonant node and a ground;
a high-side transistor, providing the input voltage to the switch node based on a high-side driving signal;
a low-side transistor, coupling the switch node to the ground based on a low-side driving signal;
a current detection circuit, detecting a resonant current flowing through the resonant capacitor to generate a current detection signal;
a feedback circuit, generating a feedback signal based on the output voltage; and
a control circuit, superpositioning the current detection signal to a slope compensation signal to generate a superposition signal and integrating the superposition signal to generate a first integral signal;
wherein the control circuit further integrates the feedback signal to generate a second integral signal and compares the first integral signal and the second integral signal to generate the high-side driving signal and the low-side driving signal.

2. The power conversion circuit as claimed in claim 1, wherein the slope compensation signal is a sawtooth wave.

3. The power conversion circuit as claimed in claim 1, wherein the second integral signal is a product of the feedback signal and an on-time;
wherein the on-time is one of an on-time of the high-side transistor, an on-time of the low-side transistor, and a switching period;
wherein the high-side driving signal and the low-side driving signal have the switching period.

4. The power conversion circuit as claimed in claim 3, wherein when the high-side transistor is turned on, the second integral signal is a product of the feedback signal and the on-time of the high-side transistor in a previous conduction period;
wherein when the low-side transistor is turned on, the second integral signal is a product of the feedback signal and the on-time of the low-side transistor in a previous conduction period.

5. The power conversion circuit as claimed in claim 3, wherein when the high-side transistor or the low-side transistor is turned on, the second integral signal is a product of the feedback signal and the switching period.

6. The power conversion circuit as claimed in claim 1, wherein the control circuit further comprises:
a superposition circuit, superpositioning the current detection signal to the slope compensation signal to generate the superposition signal; and
a first integral circuit, integrating the superposition signal to generate the first integral signal;
wherein when the high-side transistor is turned on, the superposition circuit adds the slope compensation signal to the current detection signal to generate the superposition signal;
wherein when the low-side transistor is turned on, the superposition circuit subtracts the slope compensation signal from the current detection signal to generate the superposition signal.

7. The power conversion circuit as claimed in claim 1, wherein the control circuit further comprises:
a full-wave rectification device, full-wave rectifying the first integral signal to generate a full-wave rectification signal; and
a comparator, comparing the full-wave rectification signal and the second integral signal;
wherein when the full-wave rectification signal exceeds the second integral signal, the control circuit turns off the high-side transistor or turns off the low-side transistor.

8. The power conversion circuit as claimed in claim 7, wherein when the high-side transistor is turned on and the full-wave rectification signal drops to not exceeding the second integral signal, the control circuit turns off the high-side transistor;
wherein when the low-side transistor is turned on and the full-wave rectification signal drops to not exceeding the second integral signal, the control circuit turns off the low-side transistor.

9. The power conversion circuit as claimed in claim 1, wherein the control circuit further comprises:
a first error amplifier, comparing the second integral signal and a reference voltage to generate an upper limit voltage;
a second error amplifier, comparing the reference voltage and the second integral signal to generate a low limit voltage;
a first comparator, comparing the first integral signal and the upper limit voltage to disable the high-side driving signal; and
a second comparator, comparing the first integral signal and the lower limit voltage to disable the low-side driving signal;
wherein when the high-side transistor is turned on and the first integral signal exceeds the upper limit voltage, the first comparator disables the high-side driving signal;
wherein when the low-side transistor is turned on and the lower limit voltage exceeds the first integral signal, the second comparator disables the low-side driving signal.

10. The power conversion circuit as claimed in claim 9, wherein when the high-side transistor is turned on and the first integral signal drops to not exceeding the upper limit voltage, the control circuit turns off the high-side transistor;
wherein when the low-side transistor is turned on and the first integral signal rises to exceeding the lower limit voltage, the control circuit turns off the low-side transistor.

11. The power conversion circuit as claimed in claim 1, wherein the control circuit controls the first integral signal to track the second integral signal, thereby controlling the power conversion circuit to receive input power from the input voltage and to generate output power of the output voltage.

12. The power conversion circuit as claimed in claim 1, wherein on-time of the high-side transistor is equal to on-time of the low-side transistor.

13. The power conversion circuit as claimed in claim 1, further comprising:
a rectification circuit, coupled to the secondary coil;
wherein the rectification circuit is configured to convert energy of the secondary coil into the output voltage.

14. A power conversion circuit for converting an input voltage into an output voltage, comprising:
a transformer, comprising a primary coil and a secondary coil, wherein the primary coil is coupled between a switch node and a resonant node;
a resonant capacitor, coupled between the resonant node and a ground;
a high-side transistor, providing the input voltage to the switch node based on a high-side driving signal;
a low-side transistor, coupling the switch node to the ground based on a low-side driving signal;
a voltage detection circuit, detecting a voltage across the resonant capacitor to generate a voltage detection signal;
a feedback circuit, generating a feedback signal based on the output voltage; and
a control circuit, superpositioning the voltage detection signal to a slope compensation signal to generate a superposition signal and integrating the feedback signal to generate an integral signal;
wherein the control circuit further compares the integral signal and the superposition signal to generate the high-side driving signal and the low-side driving signal.

15. The power conversion circuit as claimed in claim 14, wherein the slope compensation signal is an integration of a sawtooth wave over time.

16. The power conversion circuit as claimed in claim 14, wherein the slope compensation signal is a parabolic wave.

17. The power conversion circuit as claimed in claim 14, wherein the integral signal is a product of the feedback signal and an on-time;
wherein the on-time is one of an on-time of the high-side transistor, an on-time of the low-side transistor, and a switching period;
wherein the high-side driving signal and the low-side driving signal have the switching period.

18. The power conversion circuit as claimed in claim 17, wherein when the high-side transistor is turned on, the integral signal is a product of the feedback signal and the on-time of the high-side transistor in a previous conduction period;
wherein when the low-side transistor is turned on, the integral signal is a product of the feedback signal and the on-time of the low-side transistor in a previous conduction period.

19. The power conversion circuit as claimed in claim 17, wherein when the high-side transistor or the low-side transistor is turned on, the integral signal is a product of the feedback signal and the switching period.

20. The power conversion circuit as claimed in claim 14, wherein the control circuit further comprises:
a superposition circuit, superpositioning the current detection signal to the slope compensation signal to generate the superposition signal;
wherein when the high-side transistor is turned on, the superposition circuit adds the slope compensation signal to the current detection signal to generate the superposition signal;
wherein when the low-side transistor is turned on, the superposition circuit subtracts the slope compensation signal from the current detection signal to generate the superposition signal.

21. The power conversion circuit as claimed in claim 14, wherein the voltage detection circuit comprises:
a voltage divider, dividing a voltage across the resonant capacitor to generate the voltage detection signal.

22. The power conversion circuit as claimed in claim 14, wherein the control circuit further comprises:
a full-wave rectification device, full-wave rectifying the superposition signal to generate a full-wave rectification signal; and
a comparator, comparing the full-wave rectification signal and the integral signal;
wherein when the full-wave rectification signal exceeds the integral signal, the control circuit turns off the high-side transistor or turns off the low-side transistor.

23. The power conversion circuit as claimed in claim 22, wherein when the high-side transistor is turned on and the full-wave rectification signal drops to not exceeding the integral signal, the control circuit turns off the high-side transistor;
wherein when the low-side transistor is turned on and the full-wave rectification signal drops to not exceeding the integral signal, the control circuit turns off the low-side transistor.

24. The power conversion circuit as claimed in claim 14, wherein the control circuit further comprises:
a first error amplifier, comparing the integral signal and a reference voltage to generate an upper limit voltage;
a second error amplifier, comparing the reference voltage and the integral signal to generate a low limit voltage;
a first comparator, comparing the superposition signal and the upper limit voltage to disable the high-side driving signal; and
a second comparator, comparing the superposition signal and the lower limit voltage to disable the low-side driving signal;
wherein when the high-side transistor is turned on and the superposition signal exceeds the upper limit voltage, the first comparator disables the high-side driving signal;
wherein when the low-side transistor is turned on and the lower limit voltage exceeds the superposition signal, the second comparator disables the low-side driving signal.

25. The power conversion circuit as claimed in claim 24, wherein when the high-side transistor is turned on and the superposition signal drops to not exceeding the upper limit voltage, the control circuit turns off the high-side transistor;
wherein when the low-side transistor is turned on and the superposition signal rises to exceeding the lower limit voltage, the control circuit turns off the low-side transistor.
